(19) United States
(12) Patent Application Publication
(10) Pub. No.: US 2023/0172177 A1
(43) Pub. Date: Jun. 8, 2023

(54) FISHING HOOK AND TACKLE

(71) Applicant: ADVANCED ANGLING MATERIALS, INC., Tiverton, RI (US)

(72) Inventors: Miles C. WILSON, Tiverton, RI (US); James M. WILSON, Newcastle, ME (US)

(21) Appl. No.: 18/160,287

(22) Filed: Jan. 26, 2023

Related U.S. Application Data
(62) Division of application No. 17/479,981, filed on Sep. 20, 2021.
(60) Provisional application No. 63/080,226, filed on Sep. 18, 2020.
(60) Provisional application No. 63/168,747, filed on Mar. 31, 2021.

(51) Int. Cl. A01K 83/00

(52) U.S. Cl. CPC A01K 83/00

(57) ABSTRACT

A fishing hook includes a base, and a coating, the coating covering the base and providing corrosion resistance to the base.

### CROSS REFERENCE TO RELATED APPLICATIONS

This application is a divisional of U.S. patent application Ser. No. 17/479,981 filed Sep. 20, 2021, which claims priority to U.S. Provisional Patent Application Ser. No. 63/080,226, filed Sep. 18, 2020, and U.S. Provisional Patent Application Ser. No. 63/168,747, filed Mar. 31, 2021, all of which are incorporated by reference in their entireties.

### BACKGROUND OF THE INVENTION

This invention generally relates to outdoor sports, and more specifically to a fishing hook and tackle.

In general, a fish hook is a tool used for catching fish by impaling a fish in the mouth. Fish hooks have been employed by anglers to catch fresh and saltwater fish. Fish hooks are generally attached to some form of a line or through an eyelet which is located at one end of a fish hook. A significant variety of fish hooks are used to catch fish. Fish hooks vary in size, designs, shapes and materials. Fish hooks are designed to hold various types of artificial, processed, dead or live baits (i.e., bait fishing), to act as the foundation for artificial representations of fish prey (i.e., fly fishing), or to be attached to or integrated into other devices that represent fish prey (i.e., lure fishing).

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an article including a fishing tackle constructed of a corrosion resistant material that provides tensile or flexural modulus properties to the fishing tackle.

In another aspect, the invention features a fishing hook including a base, and a coating, the coating covering the base and providing corrosion resistance to the base.

In still another aspect, the invention features an article including a fishing hook formed from a composition of bio-degradable poly (lactic acid).

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an illustration of an exemplary fishing hook.

FIG. 2 is a table.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Many previous fishing hooks are made using metals such as iron. While metals are strong and sturdy, they tend to corrode when exposed to significant moisture, especially to sea salt water, as well as being stored in containers with high degree of moisture.

Hence, several attempts have been made in the past to prevent corrosion of iron by anodizing the metals or using steel which is an alloy of iron and carbon containing less than 2% carbon and 1% manganese or stainless steel alloys which is an alloy of iron with chromium, manganese, silicon, carbon and, in many cases, with significant amounts of nickel and molybdenum. However, both steel and stainless steel or other metal alloys have inferior tensile or flexural modulus properties and the hooks made out of them are prone to oxidation which results in a subsequent decrease in the modulus of rupture and overall strength of the hook.

In one embodiment, the present invention provides fishing tackle constructed using corrosion resistant materials that provide superior tensile or flexural modulus properties. The term “corrosion resistant material” is intended to represent material which does not corrode or oxidize easily when exposed to water, salt water, moisture, and the like.

In another embodiment, the present invention provides a corrosion resistant fishing hook/tackle made out of corrosion resistant materials selected from epoxy materials, ceramics, coated metal, composite epoxy materials, carbon fiber, natural fiber, Kevlar, and graphene.

In another embodiment, the present invention provides a fishing hook including a base material coated with corrosion resistant materials selected from epoxy materials, ceramics, composite epoxy materials, carbon fiber, natural fiber, coated metal, Kevlar, and graphene.

In still another embodiment, the present invention provides a fishing hook is formed from a composition comprising bio-degradable poly (lactic acid) reinforced with silk fibroin or hemp or flax or wool or leaf fibers or other natural fibers.

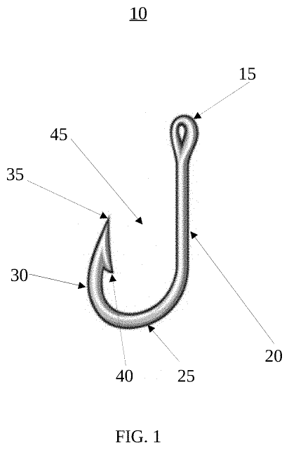

In FIG. 1, an exemplary fish hook (also referred to as “tackle”) 10 includes an eye 15, a shank 20, a bend 25, a throat 30, a point 35, a barb 40 and a gap 45. While fish hook 10 is one example, embodiments of the invention may be used with tackle of all shapes and sizes, such as, for example, a treble hook, a dual hook, a swivel, a circle hook, a ball bearing swivel, a barrel swivel, a quick swivel, a bait hook, as so forth.

In one embodiment, the fish hook 10 is made with materials coated with metallic coatings. Illustrative examples of metallic coatings include fine-grained metallic coatings with an average grain size between 1 and 1,000 nm and metal matrix composite coatings exhibiting a coefficient of thermal expansion (CTE) in the range of −5×10⁻⁶K⁻¹ to 25×10⁻⁶K⁻¹ at room temperature. Metal matrix composites (MMCs) in this context are defined as particulate matter embedded in a fine-grained metal matrix.

The fine grained material coatings are formed on substrates or can be a part of multi-layer laminates composed of alternating layers of fine-grained coatings and substrates capable of withstanding at least one 1, preferably 5 to 20 and even up to 30 temperature cycles between liquid nitrogen (T=˜−196° C. for one minute) and hot water (T=˜90° C. for one minute) without delamination and with a displacement of the coating relative to the underlying substrate of under 2%, preferably under 1% and even more preferably under 0.5%.

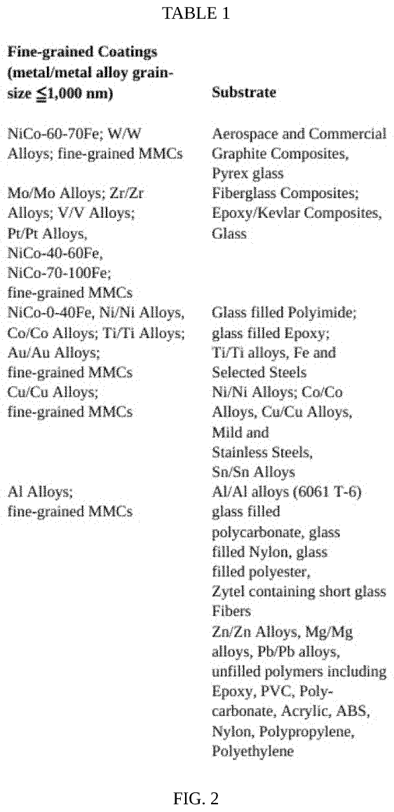

Suitable permanent substrates for the fine grain metallic coatings include metals and metal alloys, ceramics, composites and carbon-based materials selected from the group of graphite, graphite fibers and carbon nanotubes, as well as polymer materials filled with or reinforced with, for example, graphite, carbon fiber, or glass, to reduce the CTE. For strength and cost reasons, filled polymers are also desirable plastic substrate materials. The term “filled” as used herein refers to polymer resins which contain fillers embedded in the polymer, such as, for example, fibers made of graphite, carbon nanotubes, glass and metals; powdered mineral fillers (i.e., average particle size 0.2-20 microns) such as talc, calcium silicate, silica, calcium carbonate, alumina, titanium oxide, ferrite, and mixed silicates. If required, such as in the case of electrically non-conductive or poorly conductive substrates and the use of electroplating for the coating deposition, the substrates can be metallized to render them sufficiently conductive for plating. When a substrate is metallized, the fine-grained coating layer is substantially thicker than the metallized layer. The composition of the fine-grained metallic coating is selected to match the CTE of the electro-deposited metallic material with one of the permanent substrates as outlined in the TABLE 1 in FIG. 2.

In another embodiment, the fish hook 10 is made with epoxy material. Example epoxy materials include high molecular weight epoxy resin composite material having high molecular weight thermosetting resin made by reacting polyepoxides with themselves or with polyfunctional hardeners to form a thermosetting polymer, often with favorable mechanical properties and high thermal and chemical resistance. Epoxy has a wide range of applications, including metal coatings.

Epoxy materials include bis-phenol A based epoxy, aliphatic epoxy, novolaks, and halogenated epoxy (halogenated epoxy resins are admixed for special properties, in particular brominated and fluorinated epoxy resins are used.

In another embodiment, the fishing hook is made with ceramics, including glass-matrix ceramics, polycrystalline ceramics, and resin-matrix ceramics. Glass-matrix ceramics are nonmetallic inorganic ceramic materials that contain a glass phase. Glass matrix ceramics are further divided in to three sub-groups: feldspathic ceramics, synthetic ceramics, and glass-infiltrated ceramics. Illustrative examples of ceramics include feldspathic ceramics, synthetic glass ceramics, Leucite-reinforced ceramic, Fluorapatite glass-ceramics, Fluorapatite glass-ceramics, alumina, zirconia, resin-matrix ceramics, zirconia, porcelain, bone china, stoneware, silicon, silicon carbide, titanium carbide, tungsten carbide, barium titanate, boron carbide, bio-ceramic, ceramic matrix composites, alumina, cordierite, corundum, sapphire, silicon nitride, silicon carbide, boron nitride, and aluminum nitride.

In still another embodiment, the fish hook 10 uses a smart coating. Here, a smart coating is defined as a coating that changes its properties in response to an environmental stimulus.

In another embodiment, the fish hook 10 is constructed using engineering and specialty thermoplastics, such as, for example, polyether ether ketone (PEEK), polyetherketoneketone (PEKK), or polysulfone, as well as other engineering thermoplastics

In other embodiments, the fish hook 10 may be coated with corrosion resistant moisture curable polyurethanes materials, radiation curable or excess isocyanate curable thermoplastic polyurethanes, or biodegradable poly(lactic acid) coatings.

In some embodiments, the fish hook 10 may be coated with silk, hemp or biodegradable poly (lactic acid) reinforced with silk fibroin, hemp, flax, wool, basalt, and leaf fibers.

The foregoing description of the preferred embodiments of the invention is by way of example only, and other variations of the above-described embodiments and methods are provided by the present invention. The embodiments described herein have been presented for purposes of illustration and are not intended to be exhaustive or limiting. Many variations and modifications are possible in light of the foregoing teaching. The invention is limited only by the following claims.

1. An article comprising:
a fishing tackle constructed of a corrosion resistant material that provides tensile or flexural modulus properties to the fishing tackle.

2. The article of claim 1 wherein the corrosion resistant material is selected from the group consisting of an epoxy material, a ceramic material, a coated metal, a composite epoxy material, a carbon fiber, a natural fiber, a heat-resistant and strong synthetic fiber, and a graphene.

3. A fishing hook comprising:
a base; and
a coating, the coating covering the base and providing corrosion resistance to the base.

4. The fishing hook of claim 3 wherein the coating is selected from the group consisting of an epoxy material, a ceramic material, a coated metal, a composite epoxy material, a carbon fiber, a natural fiber, a heat-resistant and strong synthetic fiber, and a graphene.

5. The fishing hook of claim 3 wherein the coating is a metallic coating.

6. The fishing hook of claim 5 wherein the metallic coating is a fine-grained metallic coating with an average grain size between 1 and 10,000 nm.

7. An article comprising:
a fishing hook formed from a composition of bio-degradable poly (lactic acid).

8. The article of claim 7 wherein the bio-degradable poly (lactic acid) is reinforced with silk fibroin.

9. The article of claim 7 wherein the bio-degradable poly (lactic acid) is reinforced with hemp.

10. The article of claim 7 wherein the bio-degradable poly (lactic acid) is reinforced with flax.

11. The article of claim 7 wherein the bio-degradable poly (lactic acid) is reinforced with wool.

12. The article of claim 7 wherein the bio-degradable poly (lactic acid) is reinforced with leaf fibers.
